(19) United States
(12) Patent Application Publication
(10) Pub. No.: US 2014/0279183 A1
(43) Pub. Date: Sep. 18, 2014

(54) Method and System for Appearance-Related Commerce

(71) Applicant: Personalized Beauty Discovery, Inc., San Mateo, CA (US)

(72) Inventors: Zhanibek Datbayev, Pavlodar (KZ); Raúl Esteban Ochoa, San Francisco, CA (US); Mikhail Ulinich, Mountain View, CA (US); Marcelo Camberos, San Francisco, CA (US)

(73) Assignee: Personalized Beauty Discovery, Inc., San Mateo, CA (US)

(21) Appl. No.: 14/217,452

(22) Filed: Mar. 17, 2014

Related U.S. Application Data
(60) Provisional application No. 61/800,522, filed on Mar. 15, 2013.

(51) Int. Cl. G06Q 30/06

(52) U.S. Cl. CPC G06Q 30/0631; G06Q 30/0621
USPC 705/26.5

(57) ABSTRACT

Methods and systems of optimization are provided for a products subscription service in appearance-related commerce for a plurality of users that considers the relevant set of attributes of a customer against the available products in order to personalize the products contained in the customer recommended packages. A customer's physical characteristics, actions and preferences are matched with different products available during the subscription period. The process maximizes the chances the customer will receive products that are preferable and in turn increase probability of the provider retaining subscribers. Optimization is achieved by a two phase approach involving 1) determination of the beauty product combinations, i.e. determination of what items go into a set number of variety of bags/packages; and 2) assigning one of those bag types to each customer; thereby obtaining the maximum utility for the customer with the constraints of limited amount of product and product combination types.

### CROSS-REFERENCE TO RELATED APPLICATION

This application claims priority under 35 U.S.C. §119(e) to U.S. Provisional patent application No. 61/800,522 filed on Mar. 15, 2013, entitled “Method and Apparatus for Appearance Simulation and Appearance-Related Commerce”, the entire disclosure of which is hereby incorporated herein by reference for all purposes.

### FIELD OF THE INVENTION

The present invention relates to the personalization of products for customers. More specifically, it relates to a constrain optimization process and system, capable of producing a limited amount of product combinations to maximize the satisfaction of a number of customers based on existing knowledge of their tastes, preferences, and other relevant information.

### BACKGROUND

With the growth of e-commerce in recent years, recommender engines are frequently used. Recommender engines usually try to model user item preferences and identify a list of top-K most favorable items for users. Most recommender engines use one or a combination of two techniques: collaborative filtering and content-based filtering. However, these recommender engines do not provide a direct and efficient way to address a large scale of shoppers and products.

While typical recommender engines recommend which products customers might like, it does not solve the problem encountered in a subscription based service where type and amount of product for recommendation is limited and must be optimized to satisfy the most customers, and from the business end be cost efficient and within constrains of existing product quantity. There is therefore a need to solve the problem in satisfying the most customers with a limited amount of product type combinations regularly provided periodically over time, as in a subscription service of products to customers.

### SUMMARY

The objective of the present invention is an optimization process that considers the relevant set of attributes of a customer against the available products in order to personalize the products contained in the customer recommended packages. The method matches a customer's physical characteristics, actions and preferences with different products available each month of the subscription. The process maximizes the chances the customer will receive products that are preferable and in turn increase probability of the provider retaining subscribers.

The present invention is achieved through the embodiments as discussed throughout this document. According to an embodiment, a customer signs up for the product subscription, as in this case through a beauty website for receiving beauty product bags, by initially answering a series of questions including: the type of personal style the customer has; a preference as to the service stylist; level of comfort with makeup; favorite type of makeup, beauty, and hair brands; where they shop for beauty products; skin tone; skin concerns; eye color; hair color and hair type. Each month, the optimization process maps a relevant set of attributes against the products or product variations, including for example shades or colors. Each of the product-attribute interactions is assigned a value that represents the importance of that attribute for the product. Customers may select in certain attribute categories, more than a single answer.

Compared with the problems existing with past methods which do not contemplate a personalized subscription service for a large scale customer base, embodiments of the present invention have the following advantageous effects: the optimization process can meet the needs of utility (satisfaction/happiness) of customers as a whole while selecting from and providing a limited amount of beauty product combinations.

According to the method, a two phase approach involves 1) determination of the beauty product combinations, i.e. determination of what items go into a set number of variety of bags; and 2) assigning one of those bag types to each customer; thereby obtaining the maximum utility for the customer.

In one aspect, a computer implemented method for optimizing customer utility in a web-based beauty product subscription service is provided. The method comprises receiving from each user through the computer system, a plurality of user responses in a number of attribute categories; determining a limited set of relevant attributes mapped against each product of a plurality of products; assigning a value representing an importance of each relevant attribute for each product; identifying for each user, a selected set of relevant attributes; and applying an optimization sequence with constraining limitations. The optimization sequence further comprises 1) determining a plurality of product combination types, each of the product combination types having a plurality of assigned products, and 2) assigning one of the plurality of product combination types to each user.

In another aspect, a computer system for optimizing customer utility in a web-based beauty product subscription service is provided. The system comprises one or more processors, at least one storage medium (memory) storing instructions and operatively coupled to the one or more processors that, upon executing instructions from the at least one storage medium, are configured to receive from each of a plurality of users through an electronic interface, a plurality of user responses in a number of attribute categories. The system determines a limited set of relevant attributes mapped against each product of a plurality of products; assigns a value representing an importance of each relevant attribute for each product; and identifies for each user, a selected set of relevant attributes. The system applies an optimization sequence with constraining limitations. The optimization sequence further comprising: 1) determining a plurality of product combination types, each product combination type having a plurality of assigned products, and 2) assigning one of the plurality of product combination types to each user.

In another aspect, a computer program product for optimizing customer utility in a web-based beauty product subscription service is provided. The computer program is stored on a non-transitory computer-readable storage medium having instructions recorded thereon, that when executed by one or more processors, cause the one or more processors to receive from each of a plurality of users through an electronic interface, a plurality of user responses in a number of attribute categories. The program further determines a limited set of relevant attributes mapped against each product of a plurality of products; assigns a value representing an importance of each relevant attribute for each product; and identifies for each user, a selected set of relevant attributes. The program applies an optimization sequence with constraining limitations. The optimization sequence further comprising: 1) determining a plurality of product combination types, each product combination type having a plurality of assigned products, and 2) assigning one of the plurality of product combination types to each user.

These features, advantages and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates a basic flowchart of the implementation of the invention, according to embodiment of the present invention.

FIG. 2 is a schematic overview of the network graph used according to an embodiment of the present invention.

FIG. 3 is a comparison of screenshots that provide an example of the beauty quiz dimensions according to an embodiment of the present invention.

FIG. 4 is table of products mapped to customer attributes and assigned values representing the importance of the attribute for the product, according to an embodiment of the present invention.

FIG. 5 is a table listing a set of customers with relevant attributes selected by the customer, according to an embodiment of the present invention.

FIG. 6 is a table illustrating the optimization process resulting in the maximum utility determination for the group as a whole, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

Embodiments of the present invention provide an approach for the subscription service based package (bag) formation and distribution problem, when the number of bag types is limited to a (relatively small—hundreds) number of types.

In a web-based beauty recommendation tool that operates a subscription service to customers who are looking for the right products or new products to try, the aim is to satisfy the most customers even with a fixed amount and limited type of products. The inventive website service sends out bags with a fixed amount of products to customers. What products are included in each bag is based on questionnaire answers provided by each customer, an expressed interest in the products and the history of received products in the past. The objective is to maximize total customer utility (i.e. happiness/satisfaction) while satisfying hard business constraints such as existing product quantity.

According to embodiments of the present invention, the method and system for a beauty product subscription service comprises a two phase approach. The solution is a two level optimization process that is combined with two levels of constraints.

Phase 1: In phase 1, determination is made for the assignment of products to bag types. Note that once the products are assigned to bags, that assignment is fixed.

Phase 2: In phase 2, determination is made for the assignment of bags to customers, maximizing overall utility value.

With reference to FIG. 1, a general flowchart is provided according to an embodiment of the present invention. After initiating the process, the two main components of the solution—Phase 1 and Phase 2 are shown. During Phase 1 bag types and corresponding quantities are determined. Results from the Phase 1 are later used in Phase 2 in order to determine distribution of bags to customers.

FIG. 2 depicts a high level overview of the network graph that is used to solve the problem, according to an embodiment of the present invention. Phase 1 is concerned with products and determining bags/packages; while Phase 2 concerns the bags/packages and customers part of the network.

Phase 1 Determination-Assignment of Products to Bag Types

According to an embodiment of the present invention, determination of the assignment of products to bag types is achieved through a Mixed Integer Programming (MIP) model. The MIP model addresses first phase of the approach as follows:

Indices
i=1, . . . , I The products to be packaged
j=1, . . . , J The customers
k=1, . . . , K The bag types
t=1, . . . , T The customer attributes
l=1, . . . , L The customer clusters

Data
aⱼₜ Value of attribute t for customer j
wᵢₜ Happiness weight of product i for attribute t
cᵢⱼ Happiness of customer j with product i
Gᵢₖ Generalized customer happiness of including product i in bag type k
nₗ Number of customers in cluster l
sₗ The set of customers in cluster l
j Number of customers
Qᵢ Current quantity of product i available
Vᵢ Current value of product i
S Number of products in every bag
K Number of permitted package types
Qₘᵢₙ Lower bound on the quantity of products included in any bag type
Vₘᵢₙ Lower bound on the total value of products included in each of the bag types
X The set of pairwise forbidden products in any bag
B The set of pairs of products that have to be bundled together if present in the bag

Integer Variables

xᵢₖ Number of products i to include in bag type k
δᵢₖ=1 if product i is in bag type k, 0 otherwise
βᵢ_{₁}ᵢ_{₂}k=1 if products i₁, i₂ Σ B are included in bag type k, 0 otherwise

Linear Constraints

Σₖxᵢₖ≦Qᵢ ∇i (1)

xᵢₖ−Qᵢδᵢₖ≦0 ∇i, k (2)

Qₘᵢₙδᵢₖ−xᵢₖ≦0 ∇i, k (3)

Σᵢδᵢₖ=S ∇k (4)

−(1−δᵢ_di 1ₖ)M≦(xᵢ_{₁}ₖ−kᵢ_{₂}k)≦(1−δᵢ_{₂}ₖ)M ∇i₁≠i₂, k (5)

0≦δᵢₖ≦1 ∇i, k (6)

δᵢ_{₁}ₖ+δᵢ_{₂}ₖ≦1 ∇i₁≠₂ ∈ X, k (7)

0≦βᵢ_{₁}ᵢ_{₂}ₖ≦1 ∇i₁≠i₂ ∈ B, k (8)

2βᵢ_{₁}ᵢ_{₂}ₖ−δᵢ_{₁}ₖ−δᵢ_{₂}ₖ=0 ∇i₁≠i₂ ∈ B, k (9)

ΣᵢVᵢδᵢₖ≧Vₘᵢₙ∇k (10)

Σᵢₖxᵢₖ=jS (11)

where M=2S ΣᵢmaxᵢQᵢ

Explanation of Constraints

Each of the constraints according to an embodiment of the present invention is described as follows:
Constraint (1) guarantees that total products used will not exceed given products quantities.
Constraint (2) sets an upper bound on number of products included in any bag type.
Constraint (3) sets a lower bound on number of products included in any bag type.
Constraint (4) guarantees each bag type will have the same specified amount of products in it.
Constraint group (5) is intended to enforce the requirement that if two products are in the same bag type, they must be assigned to that bag in equal quantities (pairwise). This is seen from the following argument: If we consider any pair of products i₁, i₂ and any bag type k, then there are 4 possibilities:
1. δᵢ_{₁}ₖ=δᵢ_{₂}ₖ=0, then for sufficiently large M (such as we have proposed) the constraint is vauous.
2. δᵢ_{₁}ₖ=0, δᵢ_{₂}ₖ=1, then xᵢ_{₁}ₖ=0 from (2) and −M≦xᵢ_{₂}ₖ≦0 or M≧xᵢ_{₂}ₖ≧0, which is also vacuous.
3. δᵢ_{₁}ₖ=1, δᵢ_{₂}ₖ=0, then xᵢ_{₂}ₖ=0 from (2) and 0≦xᵢ_{₁}ₖ≦M.
4. δᵢ₁ₖ=1, δᵢ_{₂}ₖ=1, then (xᵢ_{₁}ₖ−xᵢ_{₂}ₖ)=0, as required. This exhausts the possibilities.
Constraint (6) sets bounds on the indicator variables δᵢₖ.
Constraint (7) restricts all bag types to exclude pairwise forbidden products.
Constraint (8) sets bounds on the bundle product indicator variables βᵢ_{₁}ᵢ_{₂}ₖ.
Constraint (9) enforces bundle products to be included together if present in the bag type.
Constraint (10) sets lower bound on the total value of each of the bag types.
Constraint (11) ensures there are enough bags in total for all customers.

The generalized “customer happiness” (utility) data Gᵢₖ expresses the overall happiness of the customer base with the inclusion of a particular product i in a bag k—particularly in a large volume bag which will go to many customers. In order to determine Gᵢₖ, first cluster all the customers into K (number of bag types, i.e. K=L) preference groups based on customer attributes (aⱼₜ). Various clustering algorithms can be applied in order to determine customer groups. One of the possible ways is to use Mini-batch K-means clustering which can handle very large datasets efficiently.

Suppose

$${\hat{a}}_{lt} = \frac{{Σ}_{j} {a}_{jt} ∀ j ∈ {s}_{l}}{{n}_{l}}$$

The value of attribute t for cluster l
\hat{p}ₗᵢΣₜâₗₜwᵢₜ Average customer happiness in cluster l with product i Then one of the ways to define generalized customer happiness is as follows:

$${G}_{ik} = \frac{{\hat{p}}_{ki} {n}_{l}}{{Σ}_{l} {n}_{l}}$$

Finally, the objective function of the model according to an embodiment of the present invention can be defined:

Maximize ΣᵢₖGᵢₖxᵢₖ

The model described above can be efficiently solved by the existing high performance mixed integer programming solvers such as Gurobi Optimizer, IBM CPLEX Optimizer, SoPlex LP solver and others.

Phase 2 Determination—Distribution of Bags to Customers

When the Phase 1 model has fixed the contents of the bags, there remains the step of distributing /assigning these bags to the customers. This phase may be formulated as the following transportation problem:

Indices
i=1, . . . , l The products to be packaged
j=1, . . . , j The customers
k=1, . . . , K The bag types
t=1, . . . , T The customer attributes
l=1, . . . , L The customer clusters

Data
\hat{p}ₗᵢ Same as defined in Phase 1.
ĥₗₖ Average customer happiness of cluster 1 with bag type k
Nₖ Number of bags of type k (fixed by Phase 1, along with the contents of k)

Integer Variables
yₗₖ Total bags of type k assigned to cluster l

Constraints

Σₗyₖₗ≦Nₖ∇k (b 12)

Σₖyₖₗ=nₗ∇l (13)

yₖₗ ≦0 ∇k, l (14)

Objective
Maximize ΣₖₗΣ_{i∈k}ĥₗₖyₗₖ

Note that ĥₗₖis computed as follows:

ĥₗₖ=Σ_{i∈k}\hat{p}ₗᵢ

Most LP (linear programming) algorithms may solve this transportation problem, but in order to handle it at the large scale (millions of customers) efficiently, the inventive process according to the present invention first splits customers into clusters based on attributes and distributes bags to each cluster. After how many bags are assigned to each cluster (yₖₗ) is determined, the same approach is then used to perform final bag assignment to each of the customers belonging to the cluster.

According to an embodiment of the present invention, as shown in FIG. 3, in the method and system for optimized customer utility in a beauty product subscription service, customers sign in and initially answer a beauty quiz when they become a member of web-based service, i.e. on the website. Beauty quiz dimensions (the questions) include attributes such as:
a. Personal style (e.g. bridal, classic, dubber, edgy, formal, natural, professional, simple, sporty, sultry, vintage);
b. Stylist (selecting the particular stylist for assistance in recommendation);
c. Level of comfort with makeup (also level of comfort with trying new brands/types);
d. Favorite make up brands/types;
e. Beauty brands/types;
f. Hair product types;
g. Shop for beauty products (e.g. where and how the customer shops, drugstores, department stores, beauty retailers, online etc.);
h. Skin tone;
i. Skin concerns (e.g. oily, large pores, dry, acne, lines/wrinkles; redness, etc.);
j. Eye color;
k. Hair color; and
l. Hair type (e.g. straight, curly, fizzy, dry/damaged, oily, limp/thin, etc.)

Depending on the category, customers may select one or more options, for example, in hair type, curly and dry. Customers also interact with the site and those interactions can be used as optimization attributes. Such interactions include for example, activity on the website/expressed interest in advertised products, history of received products in the past, or expressed feedback given on past products. A customer may return to their profile on the website to update the beauty quiz answers at any time which will then be applied to the optimization process.

As shown in the example of FIG. 4, each month a relevant set of attributes are mapped against the products or product variations (shades or colors). Each of these product-to-attribute interaction is assigned a value that represents the importance of that attribute for the product. In this case shown in FIG. 4, a customer with Blue Eyes would slightly prefer Product Y over W and any of those products over Product X.

As show in the example of FIG. 5, any single customer will have several attributes that are relevant for different products. Each month all the paying customers are listed with all the relevant attributes. All attributes are normalized to account for multiple answers to a single category. Since there is a limited amount of product, not all customers can receive their ideal choice. Those constrains (the availability of each product) is also built into the model as discussed above.

Based on customers' different utilities and the different products available, the optimization process, according to an embodiment of the present invention is run that maximizes the utility of the group as a whole. As shown in FIG. 6, the algorithm basically iterates all the product combinations for all different members and determines those combinations which would give the maximum utility. As further example, in referring back to FIG. 3, based on the customer A preferences versus customer B preferences, the utility value for customer B is higher than customer A for “Bag 1” type of products; and the utility value for customer A is higher than customer B for “Bag 2” type of products. Accordingly, customer A should receive “Bag 2” and customer B should receive “Bag 1” to maximize utility, i.e. customer satisfaction.

As discussed, a unique component of the solution is the Phase 1 process, where bag types are automatically determined given customer attributes and numerous constraints. Existing optimization algorithms are not prepared to optimize for two different aggregation levels in the context of large data sets.

According to an embodiment of the present invention, there is provided a computer implemented method for a products subscription service in appearance-related commerce for a plurality of users using a computer system in an electronic environment. As noted, the subscription service may be a web-based beauty products subscription service where beauty products are discussed, demonstrated and recommended.

The method is implemented by a computer system having one of more processors, one more storage databases and software stored on a memory operatively coupled to the processor, the software to be executed by the one or more processors for instructing the computer to run the method steps. The method comprises presenting through an electronic interface to each user (the customer) a series of questions in a plurality of categories, each question having pre-defined answer options, each answer option pertaining to an attribute. The method further comprises receiving from each user through the electronic interface, a plurality of answers and storing the answers in at least one database; determining a limited set of relevant attributes mapped against each product of a plurality of products; and assigning a value representing an importance of each relevant attribute for each product. The method further comprises identifying for each user, a selected set of relevant attributes; and normalizing attributes for multiple answers provided for a category. The method continues with applying an optimization process with constraining limitations including availability of each product; iterating all product combinations for all users; determining a plurality of combination types, each combination type having a plurality of assigned products, and assigning one of the plurality of combination types to each user. The optimization process considers the values assigned to the representative products in relation to the relevant attribute and then determines user assignments. At each period, such as monthly determination of products to be assigned to customers, the maximum utility is obtained by the method, given the customers preferences as obtained by answers provided to the system and constraint limitations of the available products. The constraint parameters are further discussed below.

The solution of the method and system of the present invention provides a more flexible way to personalize product distribution while handling complex business-related hard-constraints such as: limiting number of bag types; setting minimal total value of each of the bag types; excluding certain product pairs from the bag types; and forcing certain product pairs to be bundled in the same bag type. These constraints are identified as parameters in the optimization process of the present invention according to an embodiment of the present invention.

According to another embodiment, a computer system is provided for a web-based subscription service where beauty products are discussed, demonstrated and recommended. The system comprising one or more processors, at least one storage medium (memory) storing instructions and operatively coupled to the one or more processors that, upon executing instructions from the at least one storage medium, are configured to implement a method for maximizing customer utility with subscription products. The system is configured to receive from each of a plurality of users through an electronic interface, a plurality of user responses in a number of attribute categories; determine a limited set of relevant attributes mapped against each product of a plurality of products; assign a value representing an importance of each relevant attribute for each product; identify for each user, a selected set of relevant attributes; and apply an optimization sequence with constraining limitations. The optimization sequence further comprising: determining a plurality of product combination types, each product combination type having a plurality of assigned products, and assigning one of the plurality of product combination types to each user.

According to another embodiment, a computer program product is provided for a web-based subscription service where beauty products are discussed, demonstrated and recommended. The computer program is stored on a non-transitory computer-readable storage medium having instructions recorded thereon, that when executed by one or more processors, cause the one or more processors to receive from each of a plurality of users through an electronic interface, a plurality of user responses in a number of attribute categories; determine a limited set of relevant attributes mapped against each product of a plurality of products; assign a value representing an importance of each relevant attribute for each product; identify for each user, a selected set of relevant attributes; and apply an optimization sequence with constraining limitations. The optimization sequence further comprising: determining a plurality of product combination type, each product combination types having a plurality of assigned products, and assigning one of the plurality of product combination types to each user.

Advantages of the solution according to the embodiments of the present invention are its scalability and speed. With the method and system according to embodiments of the present invention, the solution scales up to tens of millions of users and hundreds of products. The problem complexity increases dramatically when faced with a large-scale instance with millions of users and hundreds of products. Coming up with practical solutions requires deep knowledge in areas of large-scale linear optimization, advanced network graph algorithms and distributed systems programming.

As this is an optimization process based on hard constrains, it is not expected that all customers would be satisfied with the level of personalization of a subscription product program. Yet results obtained show that only a very small fraction (less than one percent) of customers are not satisfied with the products received. The method and system has resulted in achieving significant scale while maintaining a consistent level of customer satisfaction regardless of the different levels of complexity.

The algorithms and displays presented herein are not inherently related to any particular computer or other apparatus. Various general-purpose systems may also be used with programs in accordance with the teachings herein, or it may prove convenient to construct more specialized apparatus to perform the required method steps. In addition, the present invention is not described with reference to any particular programming language. It will be appreciated that a variety of programming languages may be used to implement the teachings of the present invention as described herein.

Throughout the description and drawings, example embodiments are given with reference to specific configurations. It will be appreciated by those of ordinary skill in the art that the present invention can be embodied in other specific forms without departing from the spirit and scope of the invention. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A computer implemented method for a products subscription service in appearance-related commerce for a plurality of users using a computer system in an electronic environment, the method comprising:
receiving from each user through the computer system, a plurality of user responses in a number of attribute categories;
determining a limited set of relevant attributes mapped against each product of a plurality of products;
assigning a value representing an importance of each relevant attribute for each product;
identifying for each user, a selected set of relevant attributes;
applying an optimization sequence with constraining limitations, the sequence comprising:
determining a plurality of product combination types, each product combination type having a plurality of assigned products, and
assigning one of the plurality of product combination types to each user.

2. The method according to claim 1, further comprising presenting through an electronic interface to each user a series of questions in a plurality of categories, each question having pre-defined answer options, prior to receiving the plurality of user responses.

3. The method according to claim 1, wherein receiving a plurality of user responses in a number of attribute categories comprises receiving multiple responses for a single attribute category.

4. The method according to claim 1, wherein receiving a plurality of user responses comprises past activity of user interaction with the product subscription service.

5. The method according to claim 1, wherein the constraining limitations comprise limiting a number of product combination types.

6. The method according to claim 1, wherein the constraining limitations comprise setting a minimal total value of each of the product combination types.

7. The method according to claim 1, wherein the constraining limitations comprise excluding certain product pairs from the product combination types.

8. The method according to claim 1, wherein the constraining limitations comprise forcing certain product pairs to be bundled in the same product combination type.

9. A computer system comprising: one or more processors, at least one storage medium storing instructions and operatively coupled to the one or more processors that, upon executing instructions from the at least one storage medium, are configured to:
receive from each of a plurality of users through an electronic interface, a plurality of user responses in a number of attribute categories;
determine a limited set of relevant attributes mapped against each product of a plurality of products;
assign a value representing an importance of each relevant attribute for each product;
identify for each user, a selected set of relevant attributes;
apply an optimization sequence with constraining limitations, the sequence comprising:
determining a plurality of product combination types, each of the product combination types having a plurality of assigned products, and
assigning one of the plurality of product combination types to each user.

10. A computer program product stored on a non-transitory computer-readable storage medium having instructions recorded thereon, that when executed by one or more processors, cause the one or more processors to:
receive from each of a plurality of users through an electronic interface, a plurality of user responses in a number of attribute categories;
determine a limited set of relevant attributes mapped against each product of a plurality of products;
assign a value representing an importance of each relevant attribute for each product;
identify for each user, a selected set of relevant attributes;
apply an optimization sequence with constraining limitations, the sequence comprising:
determining a plurality of product combination types, each product combination type having a plurality of assigned products, and
assigning one of the plurality of product combination types to each user.
